(19) United States
(12) Patent Application Publication
(10) Pub. No.: US 2013/0288770 A1
(43) Pub. Date: Oct. 31, 2013

(54) GAMING MACHINE WITH SYMBOL-SPECIFIC MULTIPLIERS

(71) Applicant: Aristocrat Technologies Australia Pty Limited, (US)

(72) Inventor: Matthew Chan, East Killara (AU)

(73) Assignee: Aristocrat Technologies Australia Pty Limited

(21) Appl. No.: 13/708,485

(22) Filed: Dec. 7, 2012

Related U.S. Application Data
(63) Continuation of application No. 12/401,304, filed on Mar. 10, 2009, now abandoned.

(30) Foreign Application Priority Data
Mar. 10, 2008 (AU) 2008901163

(51) Int. Cl. G07F 17/32

(52) U.S. Cl. CPC G07F 17/3267
USPC 463/20

(57) ABSTRACT

A method for use with a gaming machine that is arranged to select symbols, present the symbols on a display and award an award if a winning outcome occurs. The method includes initialising a plurality of award adjustors, each award adjustor being associated with a corresponding symbol in a specified set of symbols, changing a value of each said award adjustor in response to a game event that involves the presentation of the corresponding symbol on the display; and if the winning outcome comprises a symbol from the specified set, adjusting the award dependent on the award adjustor associated with the symbol in the winning outcome.

### CROSS-REFERENCE TO RELATED APPLICATIONS

The present application claims the benefit of priority to U.S. patent application Ser. No. 12/401,304, filed on Mar. 10, 2009, entitled “GAMING MACHINE WITH SYMBOL-SPECIFIC MULTIPLIERS,” and Australian Provisional Patent Application No. 2008901163, filed on Mar. 10, 2008, entitled “GAMING MACHINE WITH SYMBOL-SPECIFIC MULTIPLIERS”, both of which are herein incorporated by reference in their entireties.

### FIELD OF THE INVENTION

The present invention generally relates to gaming machines and methods of gaming. A particular embodiment of the present invention relates to games involving a plurality of multipliers associated with respective symbols.

### BACKGROUND OF THE INVENTION

With the increase of gambling at gaming venues has come increased competition between gaming venues to obtain a larger share of the total gambling spend. Gaming venue operators have therefore continuously looked for new variations and types of games in order to attract both new and return customers to their venues.

In response to this need, suppliers of gaming devices and systems have attempted to provide the sought after variety, while still developing games that comply with the relevant regulations in the jurisdiction of the gaming venue operator. Suppliers of gaming devices therefore are faced with restrictions on the types of games and gaming machines that are allowable, both in terms of the prevailing regulations and in terms of providing a return on investment to the gaming venue operators.

### SUMMARY OF THE INVENTION

According to a first aspect of the invention there is provided a method for use with a gaming machine that is arranged to select symbols, present the symbols on a display and award an award if a winning outcome occurs, the method including:

initialising a plurality of award adjustors, each award adjustor being associated with a corresponding symbol in a specified set of symbols;

changing a value of each said award adjustor in response to a game event that involves the presentation of the corresponding symbol on the display; and

if the winning outcome includes a symbol from the specified set, adjusting the award dependent on the award adjustor associated with the symbol in the winning outcome.

The award adjustors may be multipliers.

According to a second aspect of the invention there is provided a gaming machine having a display and a game controller arranged to control images of symbols displayed on the display and if a winning combination occurs the game controller awards an award, the gaming machine being arranged to:

initialise a plurality of award adjustors, each award adjustor being associated with a corresponding symbol in a specified set of symbols;
change a value of each said award adjustor in response to a game event that involves the presentation of the corresponding symbol on the display; and

if the winning outcome includes a symbol from the specified set, adjust the award dependent on the award adjustor associated with the symbol in the winning outcome.

According to a further aspect of the invention there is provided a computer program product including machine-readable program code recorded on a machine-readable recording medium, for controlling the operation of a data processing apparatus on which the program code executes to perform a method for use with a gaming machine that is arranged to select symbols, present the symbols on a display and award an award if a winning outcome occurs, the method including:

initialising a plurality of award adjustors, each award adjustor being associated with a corresponding symbol in a specified set of symbols;

changing a value of each said award adjustor in response to a game event that involves the presentation of the corresponding symbol on the display; and

if the winning outcome includes a symbol from the specified set, adjusting the award dependent on the award adjustor associated with the symbol in the winning outcome.

According to a further aspect of the invention there is provided a computer program including machine-readable program code for controlling the operation of a data processing apparatus on which the program code executes to perform a method for use with a gaming machine that is arranged to select symbols, present the symbols on a display and award an award if a winning outcome occurs, the method including:

initialising a plurality of award adjustors, each award adjustor being associated with a corresponding symbol in a specified set of symbols;

changing a value of each said award adjustor in response to a game event that involves the presentation of the corresponding symbol on the display; and

if the winning outcome includes a symbol from the specified set, adjusting the award dependent on the award adjustor associated with the symbol in the winning outcome.

According to a further aspect of the invention there is provided a data signal including the computer program described above.

Further aspects of the present invention will be apparent from the following description, given by way of example and with reference to the accompanying drawings. Also, various embodiments of the aspects described in the preceding paragraphs will be apparent from the appended claims, the following description and/or the accompanying drawings. It should be understood, however, that the present invention is not limited to the arrangements and instrumentality shown in the attached drawings.

### BRIEF DESCRIPTION OF THE DRAWINGS

FIG. 1: shows schematically a view of a gaming console suitable for implementing certain embodiments of the present invention.

FIG. 2: shows a block diagram of a gaming machine suitable for implementing certain embodiments of the present invention.

FIG. 3: shows a block diagram of components of the memory of the gaming machine represented in FIG. 2.

FIG. 4: shows schematically a network gaming system suitable for implementing certain embodiments of the present invention.

FIG. 5A: shows a flow diagram of a process performed in accordance with an embodiment of the present invention.

FIG. 5B: shows a flow diagram of a process performed in accordance with a further embodiment of the present invention.

FIGS. 6A-6E: show a series of displays of an example of a game played in accordance with the method of FIG. 5A.

FIGS. 7A-7D: show a series of displays of an example of a game played in accordance with the method of FIG. 5B.

### DETAILED DESCRIPTION OF CERTAIN EMBODIMENTS

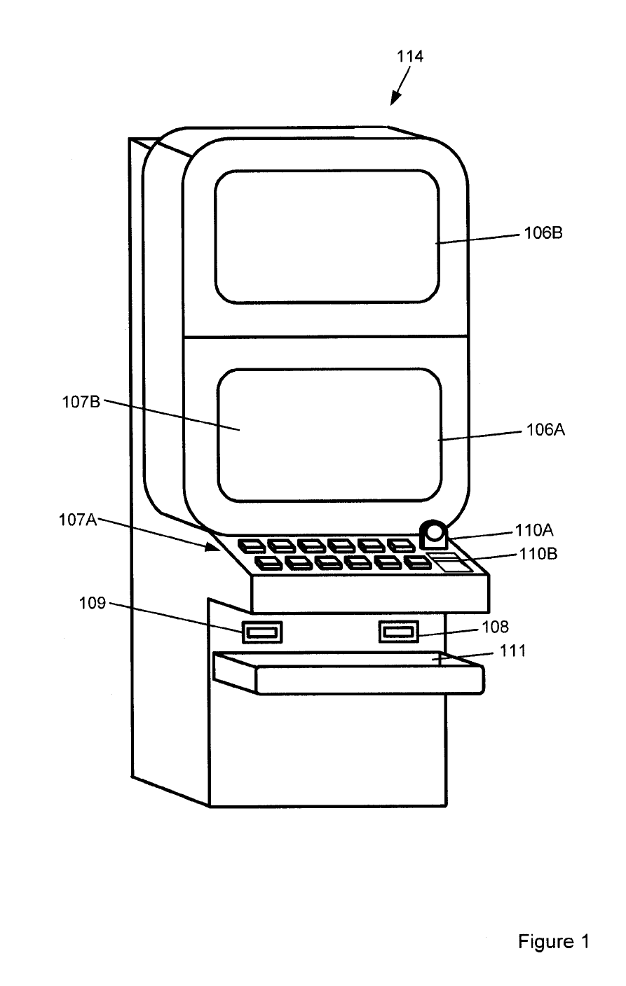

In FIG. 1 of the accompanying drawings, one example of a gaming console that is suitable to implement certain embodiments of the present invention is generally referenced by arrow 114.

The gaming console 114 includes two displays 106A, 106B on one or both of which is displayed representations of a game that can be played by a player and a bank of buttons 107A and/or a touch screen 107B to enable a player to play the game. The displays 106 may be video display units, such as a cathode ray tube screen device, a liquid crystal display, plasma screen, any other suitable video display unit, or the visible portion of an electromechanical device. The display 106B may display artwork, including for example, pay tables and details of bonus awards and other information or images relating to the game. In alternative gaming consoles the display 106B may be omitted, optionally replaced by a static display.

A credit input including a coin input 110A and/or bill collector 110B allows a player to provide credit for wagering and a coin output 111 is provided for cash payouts from the gaming console 114. A card and/or ticket reader 108 and a printer 109 may be provided to provide player tracking, cashless game play or other gaming and non-gaming related functions.

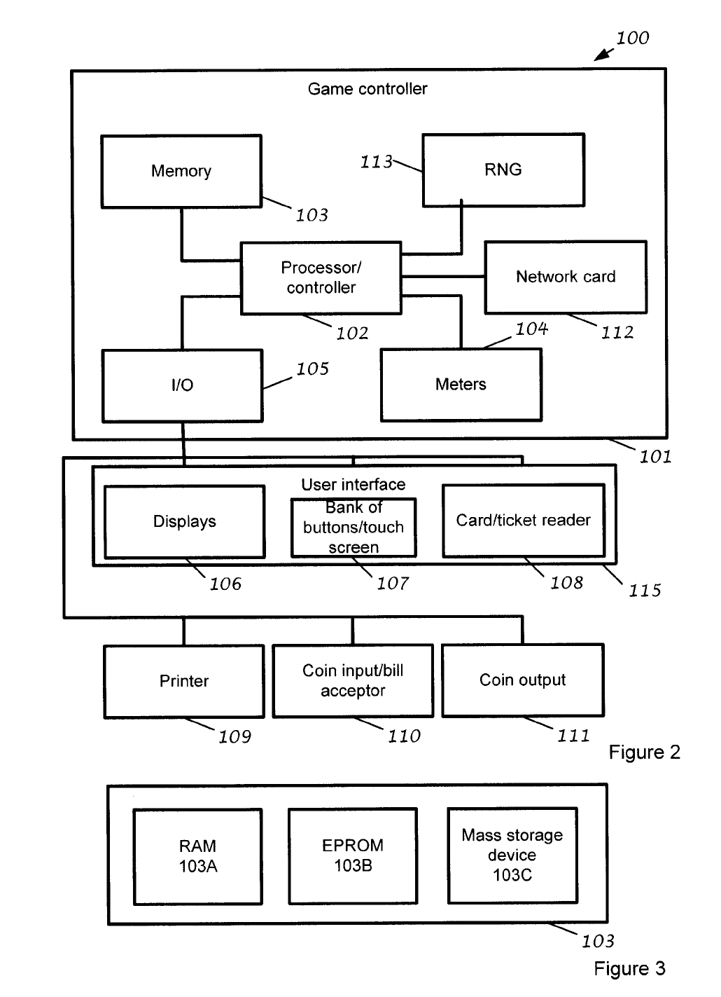

FIG. 2 shows a block diagram of a gaming machine, generally referenced by arrow 100, suitable for implementing certain embodiments of the present invention. The gaming machine 100 may include the gaming console 114 shown in FIG. 1 and accordingly like reference numerals have been used to describe like components in FIGS. 1 and 2.

The gaming machine 100 includes a game controller 101, which in the illustrated example includes a computational device 102, which may be a microprocessor, microcontroller, programmable logic device or other suitable device. Instructions and data to control operation of the computational device 102 are stored in a memory 103, which is in data communication with, or forms part of, the computational device 102. Typically, the gaming machine 100 will include both volatile and non-volatile memory and more than one of each type of memory, with such memories being collectively represented by the memory 103. The instructions to cause the game controller 101 to implement certain embodiments of the present invention will be stored in the memory 103. The instructions and data for controlling operation of the computational device 102 may be stored on a computer readable medium from which they are loaded into the gaming machine memory 103. The instructions and data may be conveyed to the gaming machine by means of a data signal in a transmission channel. Examples of such transmission channels include network connections, the Internet or an intranet and wireless communication channels.

The game controller 101 may include hardware credit meters 104 for the purposes of regulatory compliance and also include an input/output (I/O) interface 105 for communicating with the peripheral devices of the gaming machine 100. The input/output interface 105 and/or the peripheral devices may be intelligent devices with their own memory for instructions and data.

In the example shown in FIG. 2, the peripheral devices that communicate with the controller are the displays 106, bank of buttons/touch screen 107, the card and/or ticket reader 108, the printer 109, a bill acceptor and/or coin input 110 and a coin output 111. Additional devices may be included as part of the gaming machine 100, or devices omitted based on the specific implementation.

The bank of buttons 107A and/or touch screen 107B together with one or both of the displays 106 may provide a user interface 115 through which the gaming machine 100 and player communicate. If a card/ticket reader 108 is provided, this may also form part of the user interface 115.

In addition, the gaming machine 100 may include a communications interface, for example a network card 112. The network card 112, may for example, send status information, accounting information or other information to a central controller, server or database and receive data or commands from the central controller, server or database. The network card 112 may also enable communication with a central player account, allowing cashless gaming. One or more of the peripheral devices, for example the card/ticket reader 108 may be able to communicate directly with the network card 112. The network card 112 and the I/O interface 105 may be suitably implemented as a single machine communications interface.

The game controller 101 may also include a random number generator 113, which generates a series of random numbers that are used by the computational device 102 to determine the outcomes of games played on the gaming machine 100.

The game controller 101 may have distributed hardware and software components that communicate with each other directly or through a network or other communication channel. The game controller 101 may also be located in part or in its entirety remote from the user interface 115. Also, the computational device 102 may include a plurality of devices, which may be local or remote from each other. Instructions and data for controlling the operation of the user interface 115 may be conveyed to the user interface 115 by means of a data signal in a transmission channel. The user interface 115 may be a computational device, for example a personal computer, used by a person to play a game provided from a remote game controller 101.

FIG. 3 shows an exemplary block diagram of the main components of the memory 103. The RAM 103A typically temporarily holds instructions and data related to the execution of game programs and communication functions performed by the computational controller 102. The EPROM 103B may be a boot ROM device and/or may contain system and game related code. The mass storage device 103C may be used to store game programs, the integrity of which may be verified and/or authenticated by the computational controller 102 using protected code from the EPROM 103B or elsewhere.

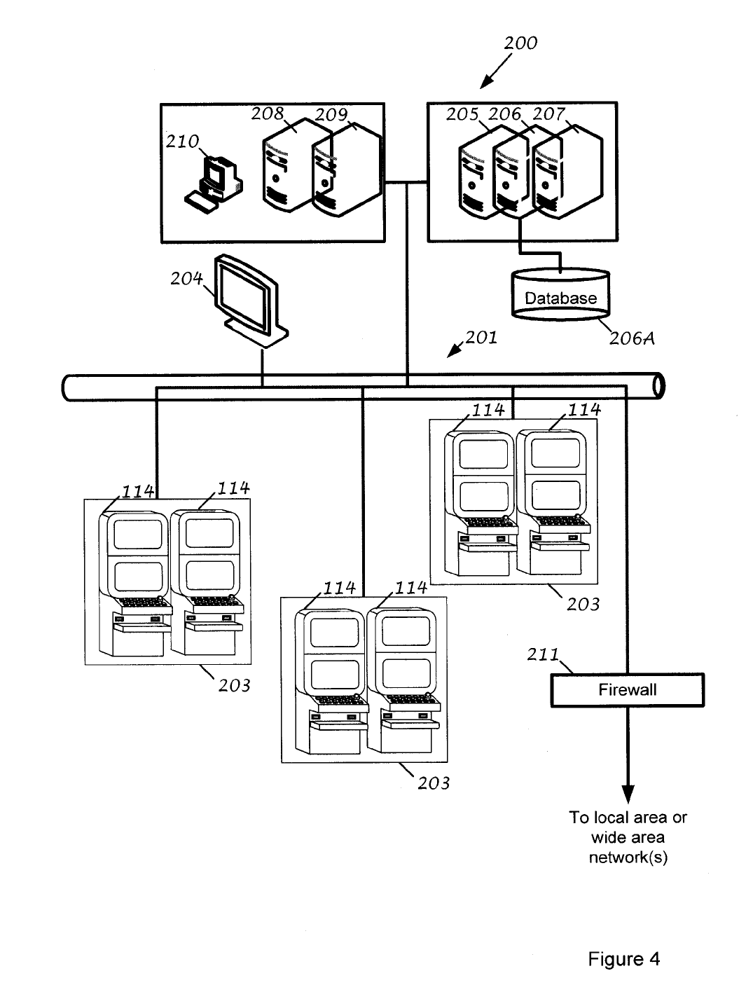

FIG. 4 shows a gaming system 200 in the form of a network of devices. The gaming system 200 includes a network infrastructure 201, which for example may be in the form of an Ethernet network. Alternatively, a wireless network and/or direct communication channels, or a different type of network may be used to link the gaming machines to a server, each other and/or other devices. Gaming consoles 114, shown arranged in three banks 203 of two gaming consoles 114 in FIG. 4, are connected to the network infrastructure 201. The gaming consoles 114 may form part or all of a gaming machine 100. Single gaming consoles 114 and banks 203 containing three or more gaming devices 202 may also be connected to the network infrastructure 201, which may also include bank controllers, hubs, routers, bridges to other networks and other devices (not shown).

One or more displays 204 may also be connected to the network 201. The displays 204 may, for example, be associated with a bank 203 of gaming consoles 114. The displays 204 may be used to display representations associated with game play on the gaming devices 202, and/or used to display other representations, for example promotional or informational material.

Servers may also be connected to the network 201. For example, a game server 205 may generate game outcomes for games played on one or more of the gaming consoles 114, a database management server 206 may manage the storage of game programs and associated data in a database 206A so that they are available for downloading to, or access by, game controllers 101, and a jackpot server 207 may control one or more jackpots for the gaming system 200.

Further servers may be provided to assist in the administration of the gaming system 200, including for example a gaming floor management server 208, and a licensing server 209 to monitor the use of licenses to particular games. An administrator terminal 210 is provided to allow an administrator to manage the network 201 and the devices connected to the network. The different servers depicted can be distinct physical servers or logically distinct server processes running on a single physical server.

The gaming system 200 may communicate with other gaming systems, other local networks, for example a corporate network and/or a wide area network such as the Internet through a firewall 211.

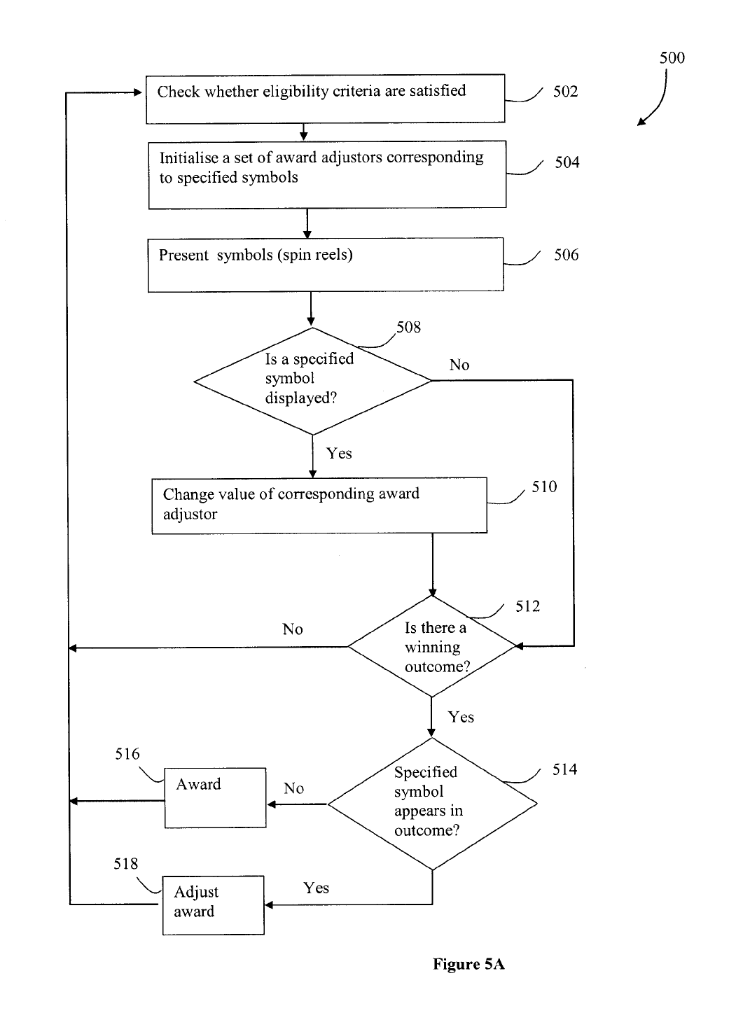

FIGS. 5A and 5B show process flow diagrams of a process performed in accordance with embodiments of the present invention. The process may be performed by the gaming system 200, in which the gaming consoles 114 each include game controllers 101 to form gaming machines 100. However, those skilled in the relevant arts will appreciate that the process will also be able to be implemented by other gaming systems.

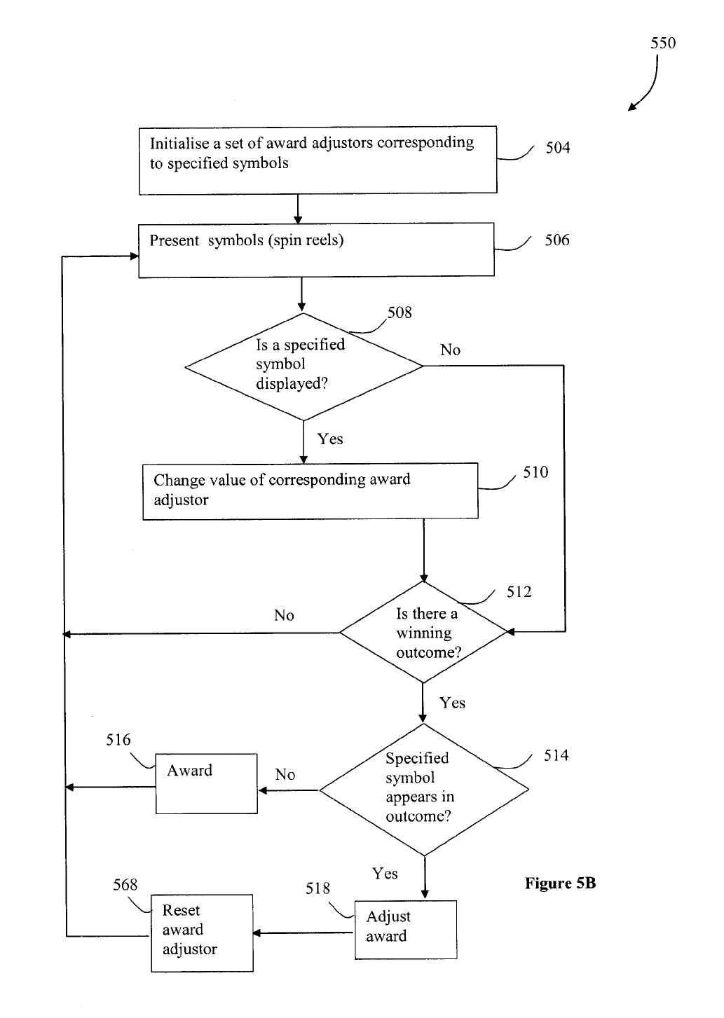

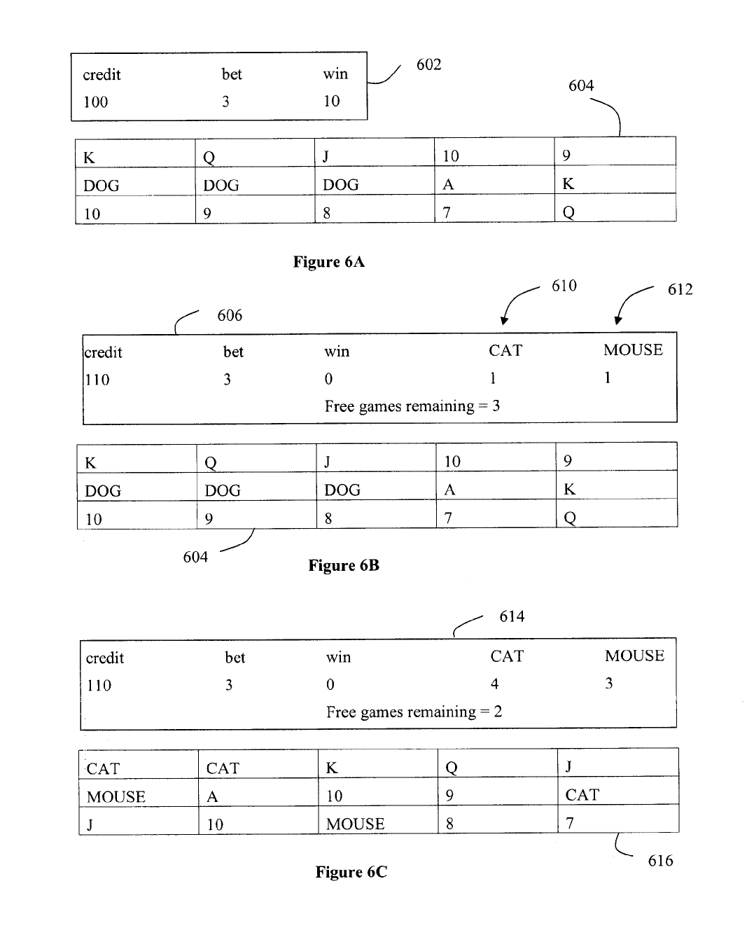

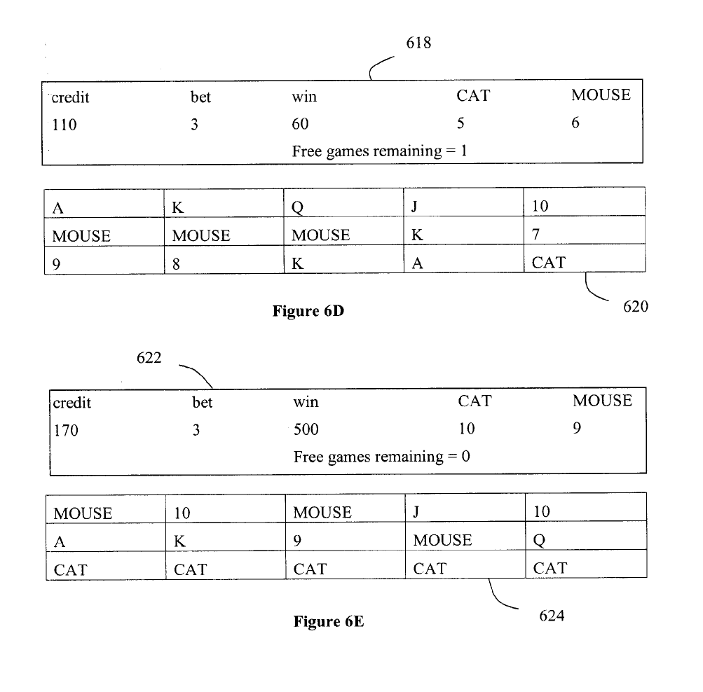

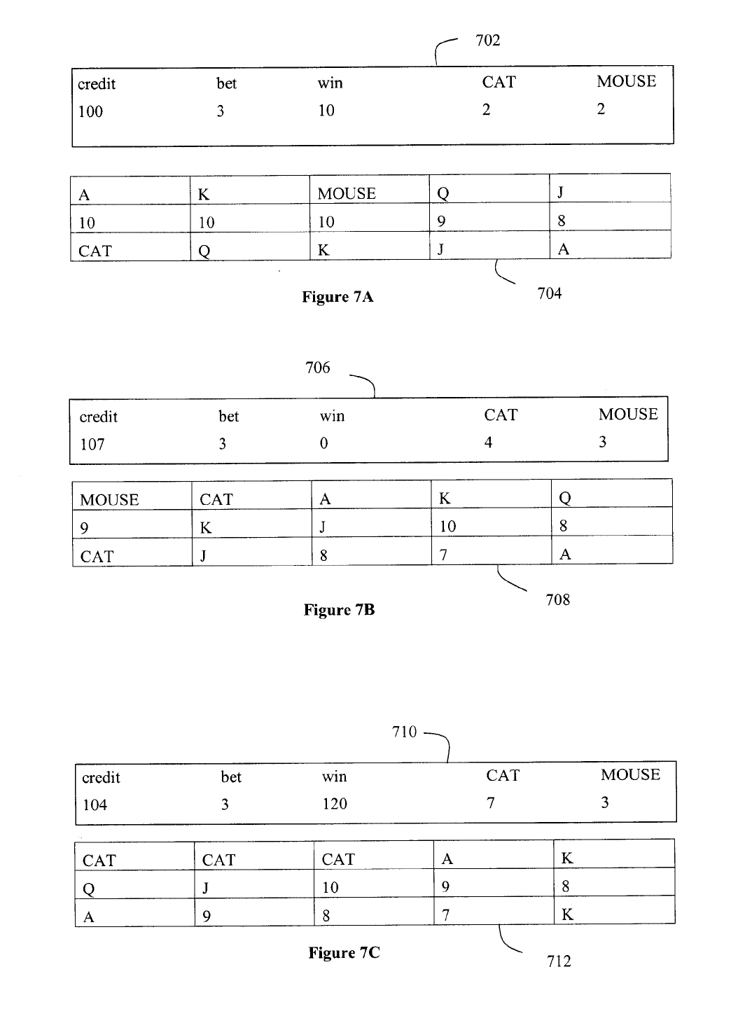

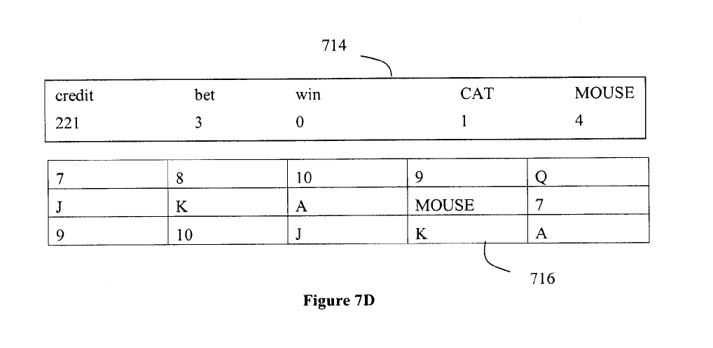

The processes of FIGS. 5A and 5B and the examples of FIGS. 6A-6E and 7A-7D are described primarily with reference to a spinning reel game in which a set of reels spin and halt to display an array of symbols. In one arrangement there are 5 spinning reels which halt to display three symbols each, ie a symbol array of 5×3 symbols is presented on the display. The spinning reels may be mechanical reels each bearing a sequence of symbols. Alternatively, the reels may be a computer animation that is rendered to display 106 to show the set of spinning reels. It will, however, be understood that the game of FIGS. 5A and 5B can also be applied to other types of games in which a set of symbols is selected and presented on a display. Examples of such games include poker games, keno games, bingo, pin and ball games and dice games.

Initially, the game controller 101 monitors the bill acceptor and/or coin input 110 and/or information received by the card/ticket reader 108 or network card 112 for a deposit of credit and in response causes the hardware meters 104 to increment according to the denomination of the game. The game controller 101 then monitors the user interface 107 for the input of a wager.

If there are sufficient credits in the meters 104 to support the wager, a game play is commenced by the game controller 101. The method 500 of FIG. 5A shows a feature game that is triggered from a base game. In stage 502 the game controller 101 determines whether one or more eligibility criteria triggering the feature have been satisfied. There are many criteria that may be used in order to trigger a feature game. Examples include an event in the base game (such as a display of a specified combination of symbols) or a machine event, such as an output triggered by the random number generator 113. The feature may also be triggered by a system event in gaming system 200. For example, if an accumulating jackpot reaches a specified threshold, a feature may be triggered. Specified events in a player-tracking system may also trigger a feature. For example, if a player has played a specified number of games or wagered a specified number of credits, a feature may be triggered. In a further example, the player may be required to purchase the feature or to place an ante bet that enables the feature to be triggered upon occurrence of a specified game event.

Once the feature has been triggered, there are further criteria that determine the duration of the feature. For example, the feature may have a fixed duration. Alternatively, a series of game plays in the feature may end if an end condition occurs. A series of feature games may also be extended if an extension condition occurs in the feature.

In some arrangements the feature is differentiated from the base game. For example, the cost of the game may change (for example, the feature games may be free), the prize values may change, the prize patterns may change and/or the set of symbols may change. New symbols may be introduced or the function of symbols may change. An example is a feature game in which one or more specified symbols become wild during the feature. In addition, the game itself may change, for example from a base game that is a spinning reel game to a card game in the feature.

At stage 504, the game controller initialises a set of award adjusters. The value of the award adjusters may be displayed to the player, for example, via display 106A. Each award adjuster corresponds to a specified symbol that is potentially displayed in the feature game. For example, the specified symbols may be included in the set of symbols associated with spinning reels in a spinning reel game. The specified symbols may be added to the total set of symbols for the feature game. Alternatively, the specified symbols may already be present in the symbol set used in the base game.

In one arrangement, each of the award adjusters is initialised to a value of 1 for each of the corresponding specified symbols. However, in other arrangements the award adjusters need not start at 1, but rather at a nominated value chosen by the game designer and defined in the rules of the game. In one arrangement all of the award adjusters are initialised to the same value. Alternatively, the initial value of the award adjusters may be different for different specified symbols. In some arrangements the initial values may be randomly selected.

In step 506, game play commences and a set of symbols is displayed on display 106. For example, in a spinning reel game, the reels are spun and halted to display a 5×3 array of symbols.

At stage 508 the game controller checks whether one or more of the specified symbols have been displayed. If so, then in step 510 the current value of the award adjuster corresponding to the displayed specified symbol is changed. In one arrangement, the award adjuster increases by a quantum of 1 for each of the corresponding special symbols which are displayed at the conclusion of step 506.

In other arrangements, the increment is not 1, but may be a larger value. Different increments may apply to different award adjusters. The value of the award adjustors may be capped in some arrangements.

In other arrangements, a display of a specified symbol may cause the corresponding award adjuster to decrease. A lower limit may be specified. For example, the game rules may determine that an award adjuster cannot fall below a value of 1. The amount used to increment or decrement the award adjusters may depend on which feature game is in play.

Once the award adjusters have been changed in step 510, process flow continues to step 512, in which the game controller checks whether a winning outcome has been displayed.

If none of the specified symbols has been displayed (the No option of step 508) then process flow also continues to step 512 to check whether a winning outcome has occurred.

If there is no winning outcome (the No option of step 512) then process flow returns to step 502 to check whether the eligibility criteria are still satisfied. If so, the feature game continues. If the eligibility criteria are no longer satisfied, the feature may terminate.

If a winning outcome is displayed, in process 514 the game controller checks whether the winning outcome includes one or more of the specified symbols.

If there are no specified symbols in the winning outcome then the award specified for the game is awarded in step 516 and process flow returns to step 502 to check whether the eligibility criteria for the feature are still satisfied.

If there are one or more of the specified symbols in the winning outcome (the Yes option of step 514) then in process 518 the game controller adjusts the award dependent on the current value of the award adjusters.

In one arrangement the award adjusters are multipliers, and the value of the award is multiplied by any multipliers associated with symbols appearing in the winning outcome.

In other arrangements, the award adjusters may affect the award in a different manner. For example, the value of the award adjuster may be added to the normal prize. For example, an amount of 50 may be added to the normal award for each CAT symbol displayed in step 506.

FIGS. 6A-6E illustrate the method of FIG. 5A. FIG. 6A shows an example of a display rendered to display 106A in the course of a base game. In the example, the base game is a spinning reel game that displays a 5×3 array of symbols 604.

A credit space 602 is displayed on displays 106 to show the player's current credit, bet and any wins. In the example, the player has bet 5 credits (1 credit on 3 lines) and wins 10 credits for the 3 DOG symbols displayed adjacent to one another on the middle row of the symbol array 604. According to the rules of the game of the example, the 3 DOG symbols also initiate a series of 3 feature games.

FIG. 6B shows how the displayed information changes when the feature is triggered. In the example, the feature games are free and any CAT or MOUSE symbol in a winning combination will multiply the value of the win by the displayed multiplier value. Each time a CAT or MOUSE symbol appears anywhere in the symbol array during the feature game, a corresponding multiplier is incremented by 1.

The information in the credit space 606 is augmented to show a multiplier 610 for the CAT symbol and a multiplier 612 for the MOUSE symbol. An indication of the number of free games remaining is also displayed.

FIG. 6C shows the outcome of the first feature game. The 5×3 symbol array 616 is shown, including 2 MOUSE symbols and 3 CAT symbols. In the credit space 614, the CAT multiplier is incremented to 4 and the MOUSE multiplier is incremented to 3. The credit space 614 shows that there are 2 free games remaining.

There are no wins in the array 616 and so no awards are made.

The outcome of the second feature game is shown in FIG. 6D. The displayed array of symbols 620 includes 1 CAT symbol, so the CAT multiplier value increases to 5. Since there are 3 MOUSE symbols, the MOUSE multiplier increases to a value of 6, as shown in the credit space 618.

The check for winning outcomes reveals that there is only one winning combination on the 3 purchased lines, namely the 3 adjacent MOUSE symbols on the centre line. This symbol combination would ordinarily give an award of 10 but in the present case the award is multiplied by 6 and so the adjusted prize is 60 and the win meter increments as shown in the credit space 618.

FIG. 6E shows the outcome of the third feature game. The reels stop to show the symbol array 624, which includes 5 CAT symbols so the CAT multiplier value increases to 10. There are 3 MOUSE symbols in the array 624, so the MOUSE multiplier increases to 9.

In evaluating the prizes, there is only a single winning combination on the 3 purchased lines, namely the 5 CAT symbols shown on the bottom of the 3 lines. This symbol combination would normally pay 50 but in this case will be multiplied by 10. The adjusted award is thus 500 as illustrated in the credit space 622.

The feature sequence is then over and the game returns to the base game.

In other arrangements, the symbol-specific multipliers need not be restricted to a feature game, but may be used in general game play. This arrangement is illustrated in method 550 in FIG. 5B. Processes 504-518 are as described with reference to FIG. 5A, and will not be discussed further. Method 550 does not have the initial step of determining whether the eligibility criteria for a base game have been satisfied.

One difference between method 550 and method 500 is that when an award has been adjusted according to an award adjuster in method 550, the corresponding award adjuster is reset to a default value in step 568.

An example of a game played in accordance with the method 550 is shown in FIGS. 7A-7D.

As shown in FIG. 7A, the player plays a normal game at 1 credit per line. Three lines are played so the total bet is 3, as shown in the credit space 702.

One MOUSE symbol and 1 CAT symbol appear in the symbol array 704 and so the CAT and MOUSE counters in the credit space 702 are incremented by 1. There is a winning pattern on the centre line of 3 adjacent 10 symbols. The player wins 10 credits. Because of the winning outcome does not include a CAT or a MOUSE symbol, the award is not adjusted.

FIG. 7B shows an outcome from the next reel spin. The player plays a normal game at 1 credit per line. Three lines are played so the total bet is 3. The credit meter has increased by 10 for the prior win and has been decreased by 3 for the wager.

One MOUSE symbol and 2 CAT symbols appear in the symbol array 708 and so the CAT and MOUSE counters are incremented by 1 and 2 respectively, as shown in the credit space 706. There are no winning outcomes in the symbol array 708.

FIG. 7C shows the outcome of a third reel spin. The player bets 3 and so the credit meter decrements by a value of 3. The symbol array 712 includes 3 CAT symbols and so the CAT multiplier increments by 3 to a value of 7. There is winning outcome in the symbol array 712, namely 3 adjacent CAT symbols in the top line. The normal prize for 3 CATs is 20. Accordingly, the player is paid an adjusted award of 7×20=140.

FIG. 7D shows the outcome of a fourth reel spin. As seen in the credit space 714, the credit meter has increased by the previous win and has been decremented by the bet of 3. The CAT multiplier has been reset to a value of 1. One MOUSE symbol has been displayed in the symbol array 716, and so the MOUSE multiplier is increased to a value of 4.

There are no winning outcomes in the symbol array 716 and so no awards are made.

In an alternative embodiment, one symbol may cause, or result in eligibility for, adjustment of a multiplier or other award adjustor, but another symbol may influence how much the multiplier is changed. For example, if the MOUSE symbol is associated with a corresponding multiplier, that multiplier may be increased by one if the MOUSE symbol occurs alone, or may increase by two if a CHEESE symbol is also presented on the display. The CHEESE symbol could be presented anywhere on the display, or may have to be displayed in a certain location or in one of a number of certain locations. An example of the latter is that the CHEESE symbol may have to be displayed adjacent to the MOUSE symbol.

In another alternative, display of the MOUSE symbol alone may not result in any change in the corresponding multiplier, the multiplier only being changed when the MOUSE symbol is displayed with one or more CHEESE symbols. The amount of the change may be dependent on the number of CHEESE symbols. The amount of the change may instead be dependent on both the number of CHEESE symbols and the number of MOUSE symbols.

In the two alternatives, the CHEESE symbol could itself have a corresponding award adjustor. Otherwise the CHEESE symbol may have other functions in the game, or have the sole function of influencing the amount that the award adjustor is changed when the MOUSE symbol occurs.

While the foregoing description has been provided by way of example of the preferred embodiments of the present invention as presently contemplated, which utilise gaming machines of the type found in casinos, those skilled in the relevant arts will appreciate that certain embodiments the present invention also may have application to internet gaming and/or have application to gaming over a telecommunications network, where handsets are used to display game outcomes and receive player inputs.

Where in the foregoing description reference has been made to integers having known equivalents, then those equivalents are hereby incorporated herein as if individually set forth.

Those skilled in the relevant arts will appreciate that modifications and additions to the embodiments of the present invention may be made without departing from the scope of the present invention.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

It will be appreciated by persons skilled in the art that numerous variations and/or modifications may be made to the invention as shown in the specific embodiments and/or aspects without departing from the spirit or scope of the invention as broadly described. The present embodiments and aspects are, therefore, to be considered in all respects as illustrative and not restrictive. Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. It will be understood that the invention disclosed and defined in this specification extends to all alternative combinations of two or more of the individual features mentioned or evident from the text or drawings. All of these different combinations constitute various alternative aspects of the invention.

The present invention contemplates methods, systems and program products on any electronic device and/or machine-readable media suitable for accomplishing its operations. Certain embodiments of the present invention may be implemented using an existing computer processor and/or by a special purpose computer processor incorporated for this or another purpose or by a hardwired system, for example.

Embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

1. A method for use with a gaming machine that is arranged to select symbols, present the symbols on a display and award an award if a winning outcome occurs, the method comprising:
initialising a plurality of award adjustors, each award adjustor being associated with a respective symbol in a specified set of symbols;
changing a value of each said award adjustor in response to a game event that involves the presentation of the associated respective symbol on the display; and
if the winning outcome is formed from the associated respective symbols, adjusting the award payable to the player for that winning outcome, the award being adjusted dependent on the award adjustor associated with the respective symbols.

2. A method according to claim 1 wherein the award adjustors are multipliers and adjusting the award comprises multiplying the award by the value of one or more of the multipliers.

3. A method according to claim 1 wherein changing the value of the award adjustor comprises incrementing the award adjustor for each occurrence of the corresponding symbol.

4. A method according to claim 3 wherein the value of the award adjustor is incremented by an amount greater than one for each occurrence of the corresponding symbol.

5. A method according to claim 1 comprising decrementing at least one award adjustor if a predetermined symbol is displayed on the display.

6. A method according to claim 1 comprising resetting at least one award adjustor to a default value if the at least one award adjustor is used to adjust an award.

7. A method according to claim 1, wherein the value each said award adjustor is changed by a value related to the number of times the corresponding symbol is displayed.

8. A method according to claim 1, wherein the value each said award adjustor is changed is also dependent on the occurrence of a further symbol, different from the corresponding symbol.

9. A method according to claim 8, wherein when the further symbol is displayed on the display together with the corresponding symbol, the award adjustor is increased by an amount more than if the corresponding symbol was displayed alone.

10. A gaming machine having a display and a game controller arranged to control images of symbols displayed on the display and if a winning combination occurs the game controller awards an award, the gaming machine being arranged to:
initialise a plurality of award adjustors, each award adjustor being associated with a respective symbol in a specified set of symbols;
change a value of each said award adjustor in response to a game event that involves the presentation of the associated respective symbol on the display; and
if the winning outcome is formed from the associated respective symbols, adjust the award payable to the player for that winning outcome, the award adjusted dependent on the award adjustor associated with the respective symbols.

11. A gaming machine according to claim 10 wherein the award adjustors are multipliers and adjusting the award comprises multiplying the award by the value of one or more of the multipliers.

12. A gaming machine according to claim 10 wherein changing the value of the award adjustor comprises incrementing the award adjustor for each occurrence of the corresponding symbol.

13. A gaming machine according to claim 12 wherein the value of the award adjustor is incremented by an amount greater than one for each occurrence of the corresponding symbol.

14. A gaming machine according to claim 10 further arranged to decrement at least one award adjustor if a predetermined symbol is displayed on the display.

15. A gaming machine according to claim 10 further arranged to reset at least one award adjustor to a default value if the at least one award adjustor is used to adjust an award.

16. A gaming machine according to claim 10, wherein the value each said award adjustor is changed by a value related to the number of times the corresponding symbol is displayed.

17. A gaming machine according to claim 10, wherein the value each said award adjustor is changed is also dependent on the occurrence of a further symbol, different from the corresponding symbol.

18. A gaming machine according to claim 17, wherein when the further symbol is displayed on the display together with the corresponding symbol, the award adjustor is increased by an amount more than if the corresponding symbol was displayed alone.

19. A computer program product comprising machine-readable program code recorded on a machine-readable recording medium, for controlling the operation of a data processing apparatus on which the program code executes to perform a method for use with a gaming machine that is arranged to select symbols, present the symbols on a display and award an award if a winning outcome occurs, the method comprising:
initialising a plurality of award adjustors, each award adjustor being associated with a respective symbol in a specified set of symbols;
changing a value of each said award adjustor in response to a game event that involves the presentation of the associated respective symbol on the display; and
if the winning outcome is formed from the associated respective symbols, adjusting the award payable to the player for that winning outcome, the award being adjusted dependent on the award adjustor associated with the respective symbols.

20. A computer program comprising machine-readable program code for controlling the operation of a data processing apparatus on which the program code executes to perform a method for use with a gaming machine that is arranged to select symbols, present the symbols on a display and award an award if a winning outcome occurs, the method comprising:
initialising a plurality of award adjustors, each award adjustor being associated with a respective symbol in a specified set of symbols;
changing a value of each said award adjustor in response to a game event that involves the presentation of the associated respective symbol on the display; and
if the winning outcome is formed from the associated respective symbols, adjusting the award payable to the player for that winning outcome, the award being adjusted dependent on the award adjustor associated with the respective symbols.
